(19) United States
(12) Patent Application Publication
(10) Pub. No.: US 2026/0202216 A1
(43) Pub. Date: Jul. 16, 2026

(54) METHOD AND DEVICE WITH GRAPH MAP UPDATE

(71) Applicant: Samsung Electronics Co., Ltd., Suwon-si (KR)

(72) Inventor: Nuri KIM, Suwon-si (KR)

(73) Assignee: Samsung Electronics Co., Ltd., Suwon-si (KR)

(21) Appl. No.: 19/265,592

(22) Filed: Jul. 10, 2025

(30) Foreign Application Priority Data
Jan. 13, 2025 (KR) 10-2025-0005041

(51) Int. Cl. G01C 21/00; G06F 40/40; G06V 10/44

(52) U.S. Cl. CPC G01C 21/3856; G01C 21/3841; G06V 10/457; G06F 40/40

(57) ABSTRACT

A method and electronic device with graph map update are provided. The electronic device includes one or more processors each including a processing circuit, and a memory including one or more storage media storing instructions. The instructions, when executed by the one or more processors individually or collectively, cause the electronic device to generate a graph map of a target area, obtain a natural language input describing a change that has occurred in the target area, and update the graph map based on a result of applying the change to the graph map using the obtained natural language input.

### CROSS-REFERENCE TO RELATED APPLICATIONS

This application claims the benefit under 35 USC § 119(a) of Korean Patent Application No. 10-2025-0005041, filed on Jan. 13, 2025, in the Korean Intellectual Property Office, the entire disclosure of which is incorporated herein by reference for all purposes.

### BACKGROUND

### 1. Field

The following description relates to a method and device with graph map update.

### 2. Description of Related Art

A robot may manage a map of a target area to facilitate navigation within the target area. When a change such as a movement or addition of an object is detected in the target area, the robot may update the map accordingly. To ensure that the map reflects the most current conditions of the environment, the robot may continuously update the map of the target area based on new observations.

The above description has been possessed or acquired by the inventor(s) in the course of conceiving the present disclosure and is not necessarily an art publicly known before the present application is filed.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

In one general aspect, a processor-implemented method includes generating a graph map of a target area; obtaining a natural language input describing a change that has occurred in the target area; and updating the graph map based on a result of applying the change to the graph map using the obtained natural language input.

The generating of the graph map may comprise adding, based on an image captured of at least a portion of the target area, an image node corresponding to the image to the graph map.

The generating of the graph map may comprise adding an object node corresponding to the object to the graph map; and adding an edge connecting an image node corresponding to the image to the object node.

The adding of the object node may comprise storing object status information indicating a status of the object together with identification information of the object node.

The generating of the graph map may comprise determining reachability between a first position corresponding to a first image node and a second position corresponding to a second image node; and adding an edge connecting the first image node to the second image node in response to a determination that traversal is possible.

The updating of the graph map may comprise determining a target place and/or a target object associated with the change, based on the natural language input; and modifying a target node corresponding to the target place and/or the target object in the graph map.

The modifying of the target node may comprise extracting, from the graph map, a sub-graph map comprising the target node, based on a result of applying an encoder to input data corresponding to the graph map and the target place and/or the target object; and updating the sub-graph map based on information associated with the target place and/or the target object.

The updating of the sub-graph map may comprise modifying node features of nodes in the sub-graph map based on the information associated with the target place and/or the target object; and adding or removing at least one edge connecting the nodes in the sub-graph map based on the modified node features.

The method may further include obtaining a command indicating a task to be performed by a robot in the target area; determining, using the updated graph map, an action for the robot to perform the task; and controlling the robot to perform the determined action.

The determining of the action may comprise determining a state of the robot in a state space of the robot; and selecting the action from a set of candidate actions based on a result of applying a reinforcement learning model to the state of the robot.

In one general aspect, a non-transitory computer-readable storage medium storing one or more instructions, wherein the one or more instructions, when executed by one or more processors of an electronic device, cause the electronic device to generate a graph map of a target area; obtain a natural language input describing a change that has occurred in the target area; and update the graph map based on a result of applying the change to the graph map using the obtained natural language input.

In one general aspect, an electronic device include one or more processors each comprising a processing circuit; and a memory comprising one or more storage media storing instructions, wherein the instructions, when executed by the one or more processors individually or collectively, cause the electronic device to generate a graph map of a target area; obtain a natural language input describing a change that has occurred in the target area; and update the graph map based on a result of applying the change to the graph map using the obtained natural language input.

The instructions, when executed by the one or more processors individually or collectively, may cause the electronic device to add, based on an image captured of at least a portion of the target area, an image node corresponding to the image to the graph map.

The instructions, when executed by the one or more processors individually or collectively, may cause the electronic device to add, based on detecting an object in an image captured of at least a portion of the target area, an object node corresponding to the object to the graph map; and add an edge connecting an image node corresponding to the image to the object node.

The instructions, when executed by the one or more processors individually or collectively, may cause the electronic device to store object status information indicating a status of the object together with identification information of the object node.

The instructions, when executed by the one or more processors individually or collectively, may cause the electronic device to determine reachability between a first position and a second position corresponding to respective image nodes; and add an edge connecting the first image node to the second image node in response to a determination of the reachability.

The instructions, when executed by the one or more processors individually or collectively, cause the electronic device to determine a target place and/or a target object based on the natural language input; and modify information on a target node in the graph map corresponding to the target place and/or the target object.

The instructions, when executed by the one or more processors individually or collectively, cause the electronic device to extract, from the graph map, a sub-graph map comprising the target node, based on a result of applying an encoder to input data corresponding to the graph map and the target place and/or the target object; and update the sub-graph map based on the target place and/or the target object.

The instructions, when executed by the one or more processors individually or collectively, cause the electronic device to change node features of nodes in the sub-graph map based on the target place and/or the target object; and add or remove at least one edge connecting the nodes based on the changed node features.

The instructions, when executed by the one or more processors individually or collectively, may cause the electronic device to obtain a task command for a robot; determine, using the updated graph map, an action for the robot; and control the robot in the target area according to the determined action.

In one general aspect, A method of updating a structured representation of a physical environment, the method includes generating, by an electronic device, a first graph map representing a physical layout of a target area, the graph map comprising a plurality of nodes and edges, wherein the plurality of nodes represent objects or positions within the target area; receiving, by the electronic device, a natural language input describing a change to the target area; extracting, based on the natural language input, a target feature representing at least one of a target object or a target location; determining, based on the target feature and the first graph map, at least one target node associated with the change; modifying, by the electronic device, one or more node features of the target node based on the natural language input; and generating a second graph map by updating the first graph map to reflect the modified node features.

Other features and aspects will be apparent from the following detailed description, the drawings, and the claims.

### BRIEF DESCRIPTION OF THE DRAWINGS

FIG. 1 illustrates an example method of updating a graph map performed by an electronic device according to one or more embodiments.

FIG. 2 illustrates an example graph map of a target area according to one or more embodiments.

FIG. 3 illustrates an example operation of updating a graph map performed by an electronic device according to one or more embodiments.

FIG. 4 illustrates a flowchart of an example method of updating a graph map performed by an electronic device according to one or more embodiments.

FIG. 5 illustrates an example electronic device according to one or more embodiments.

Throughout the drawings and the detailed description, unless otherwise described or provided, the same drawing reference numerals may be understood to refer to the same or like elements, features, and structures. The drawings may not be to scale, and the relative size, proportions, and depiction of elements in the drawings may be exaggerated for clarity, illustration, and convenience.

### DETAILED DESCRIPTION

The following detailed description is provided to assist the reader in gaining a comprehensive understanding of the methods, apparatuses, and/or systems described herein. However, various changes, modifications, and equivalents of the methods, apparatuses, and/or systems described herein will be apparent after an understanding of the disclosure of this application. For example, the sequences within and/or of operations described herein are merely examples, and are not limited to those set forth herein, but may be changed as will be apparent after an understanding of the disclosure of this application, except for sequences within and/or of operations necessarily occurring in a certain order. As another example, the sequences of and/or within operations may be performed in parallel, except for at least a portion of sequences of and/or within operations necessarily occurring in an order, e.g., a certain order. Also, descriptions of features that are known after an understanding of the disclosure of this application may be omitted for increased clarity and conciseness.

The features described herein may be embodied in different forms, and are not to be construed as being limited to the examples described herein. Rather, the examples described herein have been provided merely to illustrate some of the many possible ways of implementing the methods, apparatuses, and/or systems described herein that will be apparent after an understanding of the disclosure of this application. The use of the term “may” herein with respect to an example or embodiment (e.g., as to what an example or embodiment may include or implement) means that at least one example or embodiment exists where such a feature is included or implemented, while all examples are not limited thereto. The use of the terms “example” or “embodiment” herein have a same meaning (e.g., the phrasing “in one example” has a same meaning as “in one embodiment”, and “one or more examples” has a same meaning as “in one or more embodiments”).

Throughout the specification, when a component, element, or layer is described as being “on”, “connected to,” “coupled to,” or “joined to” another component, element, or layer it may be directly (e.g., in contact with the other component, element, or layer) “on”, “connected to,” “coupled to,” or “joined to” the other component, element, or layer or there may reasonably be one or more other components, elements, layers intervening therebetween. When a component, element, or layer is described as being “directly on”, “directly connected to,” “directly coupled to,” or “directly joined” to another component, element, or layer there can be no other components, elements, or layers intervening therebetween. Likewise, expressions, for example, “between” and “immediately between” and “adjacent to” and “immediately adjacent to” may also be construed as described in the foregoing.

Although terms such as “first,” “second,” and “third”, or A, B, (a), (b), and the like may be used herein to describe various members, components, regions, layers, or sections, these members, components, regions, layers, or sections are not to be limited by these terms. Each of these terminologies is not used to define an essence, order, or sequence of corresponding members, components, regions, layers, or sections, for example, but used merely to distinguish the corresponding members, components, regions, layers, or sections from other members, components, regions, layers, or sections. Thus, a first member, component, region, layer, or section referred to in the examples described herein may also be referred to as a second member, component, region, layer, or section without departing from the teachings of the examples.

The terminology used herein is for describing various examples only and is not to be used to limit the disclosure. The articles “a,” “an,” and “the” are intended to include the plural forms as well, unless the context clearly indicates otherwise. As non-limiting examples, terms “comprise” or “comprises,” “include” or “includes,” and “have” or “has” specify the presence of stated features, numbers, operations, members, elements, and/or combinations thereof, but do not preclude the presence or addition of one or more other features, numbers, operations, members, elements, and/or combinations thereof, or the alternate presence of an alternative stated features, numbers, operations, members, elements, and/or combinations thereof. Additionally, while one embodiment may set forth such terms “comprise” or “comprises,” “include” or “includes,” and “have” or “has” specify the presence of stated features, numbers, operations, members, elements, and/or combinations thereof, other embodiments may exist where one or more of the stated features, numbers, operations, members, elements, and/or combinations thereof are not present.

As used herein, the term “and/or” includes any one and any combination of any two or more of the associated listed items. The phrases “at least one of A, B, and C”, “at least one of A, B, or C”, and the like are intended to have disjunctive meanings, and these phrases “at least one of A, B, and C”, “at least one of A, B, or C” (e.g., each phrase may include any one of the respective items alone, all of the items listed together, and all possible combinations thereof), and the like also include examples where there may be one or more of each of A, B, and/or C (e.g., any combination of one or more of each of A, B, and C), unless the corresponding description and embodiment necessitates such listings (e.g., “at least one of A, B, and C”) to be interpreted to have a conjunctive meaning.

Unless otherwise defined, all terms, including technical and scientific terms, used herein have the same meaning as commonly understood by one of ordinary skill in the art to which this disclosure pertains and specifically in the context on an understanding of the disclosure of the present application. Terms, such as those defined in commonly used dictionaries, are to be interpreted as having a meaning that is consistent with their meaning in the context of the relevant art and specifically in the context of the disclosure of the present application, and are not to be interpreted in an idealized or overly formal sense unless expressly so defined herein.

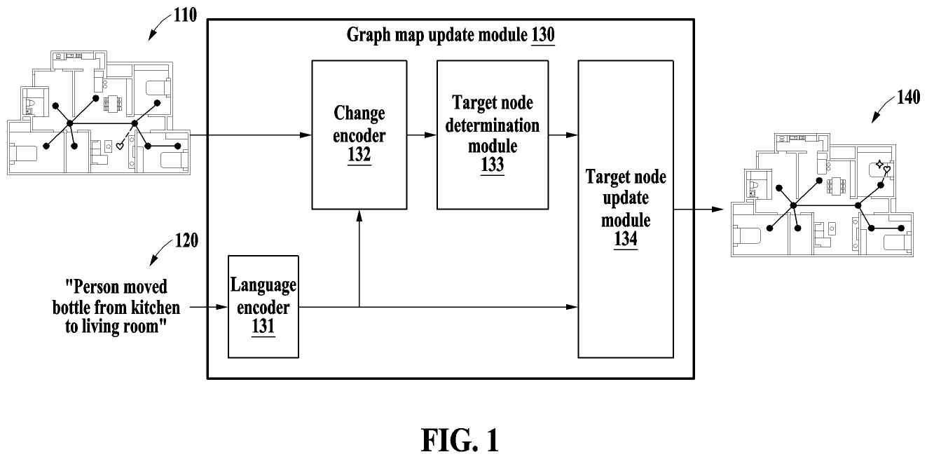

FIG. 1 illustrates an example method of updating a graph map performed by an electronic device according to one or more embodiments.

The electronic device may update a graph map representing a target area.

The target area may include at least a portion of one or more floors of a particular building. The target area may be defined as an area commonly used by a specific user or group of users within the particular building. For example, the target area may include an area (e.g., a residential area) occupied by a household in a multi-unit building, an office used by a company, and/or a leased space occupied by a tenant.

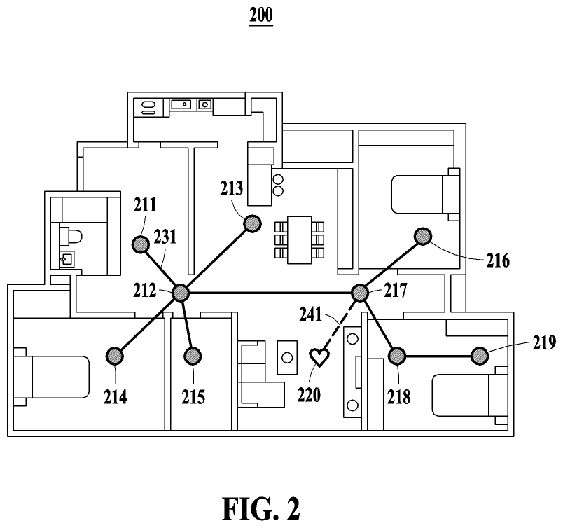

The graph map may include information on the target area. For example, the graph map may include information on a specific object placed/located within the target area and/or a specific position within the target area. The graph map may comprise one or more nodes and one or more edges. Further details regarding the structure of the graph map are provided below with reference to FIG. 2.

The electronic device may obtain (e.g., generate) a graph map (e.g., a first graph map 110) corresponding to the target area. For example, the electronic device may generate the first graph map 110 corresponding to a particular time point (e.g., a first timepoint).

The electronic device may receive a natural language input 120 describing a change that has occurred in the target area. The change that has occurred in the target area may refer to a change that occurred after the first timepoint. As a result of the change, the target area at the first timepoint and the target area at a second timepoint subsequent to the first timepoint (e.g., a timepoint after the change occurs) may be different from each other.

The change described in the natural language input 120 may include, for example, a change in a position of an object positioned in the target area. The change in a position of an object may include, for example, an object that was not positioned in the target area at the first timepoint being positioned in the target area at the second timepoint, an object that was positioned at a first position within the target area at the first timepoint moving to a second position within the target area at the second timepoint, and/or an object that was positioned in the target area at the first timepoint moving out of the target area (e.g., no longer being positioned in the target area) at the second timepoint.

The change may further include, for example, a change/modification of information on an object positioned in the target area (e.g., a change in a status of the object). The change in the status of the object may include, for example, the status of the object in a first status at the first timepoint being changed into a second status at the second timepoint. Details regarding such status changes are described below with reference to FIG. 2.

The change may further include, for example, a change/modification in whether the electronic device or another electronic device is reachable from the first position to the second position. For example, the electronic device or another electronic device may include a robot including a driver. For example, when the target area includes a living room and an adjacent room, a door between the living room and the adjacent room may be open at the first timepoint and closed at the second timepoint, affecting traversal between those areas. Specifically, at the first timepoint, the second position within the adjacent room may be reachable from the first position within the living room. At the second timepoint, the second position within the adjacent room may not be reachable from the first position within the living room.

The electronic device may update the graph map, based on a result of applying a change to the graph map using the natural language input 120. For example, instead of re-obtaining environmental data on the target area (e.g., an image captured at the first position and/or an image captured at the second location) after a change has occurred and updating the graph map based on the re-obtained data, the electronic device may update the graph map based directly on a natural language command describing the change.

Referring to FIG. 1, the electronic device may generate a second graph map 140 based on the first graph map 110 and the natural language input 120 using a graph map update module 130. The graph map update module 130 may include a language encoder 131, a change encoder 132, a target node determination module 133, and a target node update module 134.

The language encoder 131 may be configured to process the natural language input 120 to output information on a target object and/or a target location/place associated with the change that has occurred in the target area. The language encoder 131 may include a model generated and/or trained to produce output data corresponding to the target object and/or place based on input data corresponding to the natural language input 120 describing a change. The output data of the language encoder 131 may include a place feature representing the target place and/or an object feature representing the target object. The language encoder 131 may be implemented using, for example, a neural network, a transformer, and/or a large language model (LLM).

The change encoder 132 may be configured to process the first graph map 110 and information on the target place and/or the target object (e.g., output data of the language encoder 131) to determine a degree of a relevance of nodes included in the first graph map 110 to a change. For example, the change encoder 132 may generate a score indicating a degree of a relevance of each node of the first graph map 110 to a change described by the natural language input 120 (e.g., a likelihood of the change occurring in a portion or object corresponding to the node).

The target node determination module 133 may determine/select one or more target nodes from among a plurality of nodes included in the first graph map 110 based on the degree of the relevance of each node to the change. The target node may refer to a node whose associated information (e.g., a feature of the node) may be modified according to the change. For example, the target node determination module 133 may determine, from among a plurality of nodes, one or more nodes each having a score that meets or exceeds a predefined threshold score to be the target node(s). As described in more detail below with reference to FIGS. 2 to 4, some graph maps among the first graph map 110, which include the target node(s), may be represented as sub-graph maps.

The target node update module 134 may update/modify information on the target node in the first graph map 110. The electronic device may update a feature of the target node using the target node update model 134. The target node update model 134 may refer to a model generated and/or trained to generate output data from input data. The input data of the target node update model 134 may include the natural language input 120 and/or information extracted from the natural language input 120 (e.g., information on the target place and/or the target object and the output data of the language encoder 131) and the information on the target node (e.g., the feature of the target node). The output data of the target node update model 134 may include a result of the updating of the information on the target node (e.g., the updated feature of the target node). The target node update model 134 may be implemented using, for example, a neural network, a transformer, and/or an LLM.

All or a portion of components of the graph map update module 130 (e.g., the language encoder 131, the change encoder 132, the target node determination module 133, and the target node update module 134) may be implemented as hardware and/or software modules. When a component of the graph map update module 130 is implemented in software, the software modules may include instructions, when executed by one or more processors, may cause the electronic device to perform operations directed by the instructions.

Using the updated information on the target node output by the graph map update module 130, the electronic device may generate the second graph map 140. For example, the electronic device may generate the second graph map 140 by replacing the feature of the target node in the first graph map 110 with the updated feature, and/or changing (e.g., adjusting, deleting, and adding) edges between the nodes in the first graph map 110 based on the updated feature.

FIG. 2 illustrates an example graph map of a target area according to one or more embodiments.

A graph map 200 (e.g., the first graph map 110 of FIG. 1 and the second graph map 140 of FIG. 1) may represent information associated with the target area. As described above with reference to FIG. 1, the graph map 200 may include one or more nodes and one or more edges. An edge may connect two nodes in the graph map 200.

Each node may correspond to a specific position/location within the target area or to a specific object positioned within the target area. A node may be classified as either an image node (e.g., a first image node 211 through a ninth image node 219) or an object node (e.g., object node 220).

Referring to FIG. 2, the graph map 200 may include nine image nodes (e.g., the first image node 211, a second image node 212, a third image node 213, a fourth image node 214, a fifth image node 215, a sixth image node 216, a seventh image node 217, an eighth image node 218, and the ninth image node 219) and one object node (e.g., the object node 220).

Each image node may correspond to at least a portion of the target area. An electronic device may, based on an image captured of at least a portion of the target area, add an image node corresponding to the image (or a portion of the target area shown in the image) to the graph map 200.

The image may include a panoramic image captured by a vision sensor (e.g., a camera) that rotates 360 degrees about a specific axis (e.g., an axis perpendicular to a floor surface) while positioned at a specific position/location within the target area. A position associated with an image node may correspond to the location of the vision sensor when capturing the image. For example, the first image node 211 may be added to the graph map 200 based on an image captured at a first position in the target area.

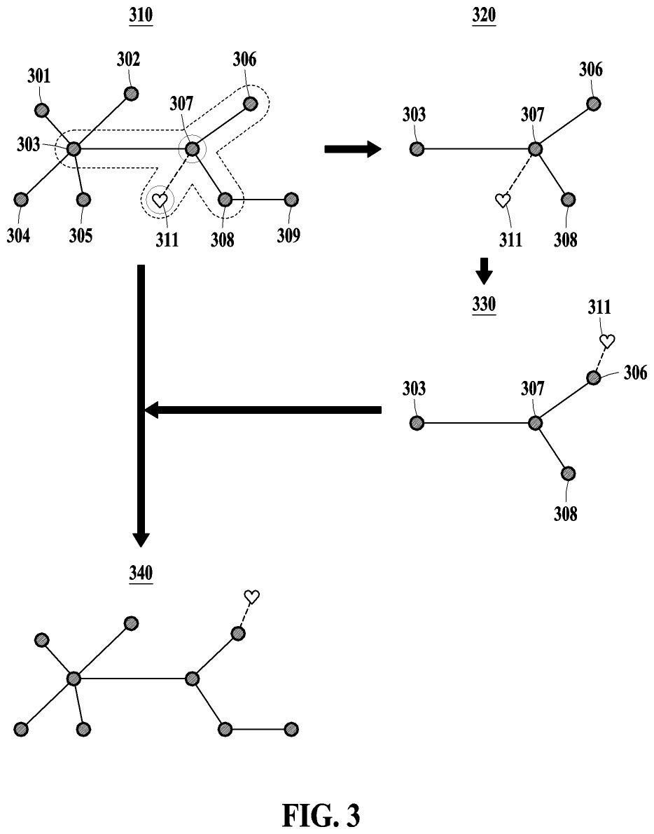

The graph map 200 may include information on each image, along with identification information of the corresponding image node. The information on each image may include image features extracted from the image, and/or position information associated with the image node. Further details on image features extraction are described below with reference to FIG. 3. The position information associated with the image node may include a type of space associated with the position (e.g., a living room type, a bedroom type, a kitchen type, and a dressing room type) and/or a coordinate of the position. For example, the electronic device may store the image information together with the identification information of the corresponding image node.

The object node 220 may represent an object located within the target area. The electronic device may add the object node 220 corresponding to the object to the graph map 200, based on detection of the object in the image captured of at least a portion of the target area.

The graph map 200 may include object information together with identification information of the object node 220. The object information may include object category information, object visual property information, and/or object status information. For example, the electronic device may store the object information together with the identification information of the object node 220. For example, the electronic device may store the object information tagged (or labeled) with the identification information of the object node 220.

The object category information may include indicate one category assigned to the object from among a set of candidate categories of the object (e.g., a table category, a chair category, a fruit category, a bed category, a pillow category, and a light category). The object visual property information may include information indicating characteristics such as a color of the object, a size of the object, and/or a shape of the object.

The object status information may represent a status of the object. For example, for an electronic device, the status of the object may include whether the object is powered on or off. For containers (e.g., a box, cup, or sink) having an internal space that may accommodate things, the status of the object may include a degree to which the object is filled with things (e.g., empty or full). For objects such as fruit, the state of the object may include whether the object is intact or cut (e.g., whole or halved). Additionally, the state of an object may reflect the object's placement context (e.g., located in a kitchen or in a living room).

An edge between two image nodes may indicate that an electronic device (e.g., a robot) is reachable (e.g., capable of traveling) from a position corresponding to one image node to a position corresponding to another image node. For example, referring to FIG. 2, the electronic device may add an edge 231 connecting the first image node 211 and the second image node 212 to the graph map 200 in response to the electronic device being able to reach a position corresponding to the second image node 212 from a position corresponding to the first image node 211. The concept of reachability may include the ability of the electronic device to physically move the second position when starting from the first position.

An edge connecting an image node to the object node 220 (e.g., an edge between an image node and the object node 220) may indicate that an object represented by the object node 220 appears in an image associated with the image node (e.g., the object is visible in the image). For example, the electronic device may add the object node 220 corresponding to the object to the graph map 200, based on detection of the object in the image captured of at least a portion of the target area. The electronic device may further add, to the graph map 200, an edge 241 connecting an image node (e.g., the seventh image node 217) corresponding to the image to the object node 220.

FIG. 3 illustrates an example operation of updating a graph map performed by an electronic device according to one or more embodiments.

The electronic device may obtain a graph map 310 (e.g., the first graph map 110 of FIG. 1) and a natural language input (e.g., the natural language input 120 of FIG. 1). As described above with reference to FIG. 1, the graph map 310 may include information on a target area at a first timepoint. The natural language input may include natural language data (e.g., text data and/or speech data) that describes a change that has occurred in the target area since the first timepoint.

Referring to FIG. 3, the graph map 310 may include a plurality of nodes (e.g., a first image node 301, a second image node 302, a third image node 303, a fourth image node 304, a fifth image node 305, a sixth image node 306, a seventh image node 307, an eighth image node 308, a ninth image node 309, and an object node 311). For example, the sixth image node 306 may correspond to a position/location within a living room area, and the seventh image node 307 may correspond to a position/location within a kitchen area of the target area. The object node 311 may represent a bottle object. At the first timepoint, the bottle object may be positioned in the kitchen area (e.g., at a position visible from a position corresponding to the seventh image node 307). The natural language input may include text describing a movement of a bottle object from the kitchen area to the living room area (e.g., “A person moved the bottle from the kitchen to the living room”).

The electronic device may determine, based on the natural language input, at least one of a target place or a target object related to the change. For example, the target place may be determined as an area surrounding a specific image node, which may be identified as a target node as described below. The electronic device may modify information associated with the target node corresponding to at least one of the target place or the target object in the graph map 310.

Referring to FIG. 3, the electronic device may determine the bottle object to be the target object. The electronic device may determine a surrounding area of the sixth image node 306 corresponding to a position within the living room area and/or a surrounding area of the seventh image node 307 corresponding to a position within the kitchen area to be the target place.

Information associated with the target node may include feature information of the target node, identification information of the target node (e.g., information on an image when the target node is an image node, or information on an object when the target node is the object node 311), and connectivity data indicating whether the target node is connected to another node via an edge.

For example, the electronic device may extract a sub-graph map 320 including the target node from the graph map 310, based on a result of applying an encoder (e.g., the language encoder 131 of FIG. 1 and/or the change encoder 132 of FIG. 1) to input data corresponding to one or more of the target place, the target object and the graph map 310.

For example, the electronic device may obtain features of the target place and/or features of the target object by applying a language encoder (e.g., the language encoder 131 of FIG. 1) to the natural language input. The electronic device may determine the target node based on a result of comparing each of features of the plurality of nodes within the graph map 310 with the features of the target place.

The electronic device may determine the target node based on a result of comparing each of the features of the plurality of nodes of the graph map 310 with the features of the target object. The target node may refer to a node related to one or more of the change, the target object, and the target place described by the natural language input. The electronic device may determine a similarity (e.g., L2 norm and cosine similarity) between features as a result of comparing the features. The electronic device may determine, from among the plurality of nodes of the graph map 310, a node as the target node when a similarity meets or exceeds a threshold.

The electronic device may extract the sub-graph map 320 including the determined target node. For example, the electronic device may extract the sub-graph map 320 including the determined target node, an edge connected to the determined target node, and a node connected to the determined target node via one edge.

Referring to FIG. 3, the electronic device may determine, from among the plurality of nodes, the sixth image node 306, the seventh image node 307, and the object node 311 to be target nodes, and include them in the sub-graph map 320. The electronic device may select the sixth image node 306, the seventh image node 307, and the object node 311, which are the target nodes, from the graph map 310, as at least a portion of the sub-graph map 320. The electronic device may select another node (e.g., the third image node 303 and the eighth image node 308) connected to the target node (e.g., the seventh image node 307) via one edge as at least a portion of the sub-graph map 320. The electronic device may select edges between the selected nodes as at least a portion of the sub-graph map 320. Referring to FIG. 3, the edges between the selected nodes may include an edge between the third image node 303 and the seventh image node 307, an edge between the sixth image node 306 and the seventh image node 307, an edge between the seventh image node 307 and the eighth image node 308, and an edge between the seventh image node 307 and the object node 311.

The electronic device may update the sub-graph map 320 based on either one or both of the target place and the target object.

The electronic device may change node features of nodes within the sub-graph map 320 based on information related to the target place and/or the target object. For example, the electronic device may change the node features of the nodes included in the sub-graph map 320, using a target node update module (e.g., the target node update module 134 of FIG. 1). The electronic device may determine an updated node feature of the target node based on a result of applying a target node update model to the features of the target place, the features of the target object, and the features of the target node.

The electronic device may remove or add one or more edges connecting the nodes within the sub-graph map 320 based on the changed/updated node features. For example, the electronic device may add or remove an edge connecting a first node and a second node based on a similarity between a changed first node feature of the first node and a changed second node feature of the second node.

Referring to FIG. 3, for example, in the sub-graph 320, a similarity between a node feature of the seventh image node 307 and a node feature of the object node 311 may meet or exceed the threshold similarity. In the sub-graph 330, a similarity between a node feature of the sixth image node 306 and the node feature of the object node 311 may be greater than or equal to the threshold similarity. In the sub-graph 330, the similarity between the node feature of the seventh image node 307 and the node feature of the object node 311 may fall below the threshold similarity.

The electronic device may change node features of nodes within the sub-graph map 320 and subsequently re-determine a similarity between the changed node features. A similarity between a changed node feature of the sixth image node 306 and a changed node feature of the object node 311 may fall below the threshold similarity. A similarity between a changed node feature of the seventh image node 307 and a changed node feature of the object node 311 may meet or exceed the threshold similarity.

The electronic device may delete the edge between the first node and the second node in response to the similarity between the changed node features of the first node and the second node falling below the threshold similarity. The electronic device may add the edge between the first node and the second node in response to the similarity between the changed node features of the first node and the second node meeting or exceeding the threshold similarity. Referring to FIG. 3, the electronic device may generate an updated sub-graph map 330 by deleting the edge between the seventh image node 307 and the object node 311 and adding an edge between the sixth image node 306 and the object node 311.

The electronic device may generate an updated graph map 340 by replacing (e.g., substituting) the sub-graph map 320 of the graph map 310 with the updated sub-graph map 330.

While the update operations described in FIG. 3 primarily involve addition and deletion of edges, the update of the graph map 310 is not limited thereto. For example, the update of the graph map 310 (or the sub-graph map 320) may include a modification to information stored together with the identification information of a node (e.g., information on an object). For example, the natural language input may include text describing a change in a status of an object from a first status to a second status. The electronic device may determine the target object and/or the target place (e.g., a place in which the target object is positioned) based on the natural language input. The electronic device may determine the object node 311 corresponding to the target object to be the target node. The electronic device may change a node feature of the target node from a first value (e.g., indicating that a status of the target object is the first status) to a second value (e.g., indicating that the status of the target object is the second status). The electronic device may, based on the changed node feature of the target node, modify object status information stored together with the identification information of the target node corresponding to the target object in the graph map 310.

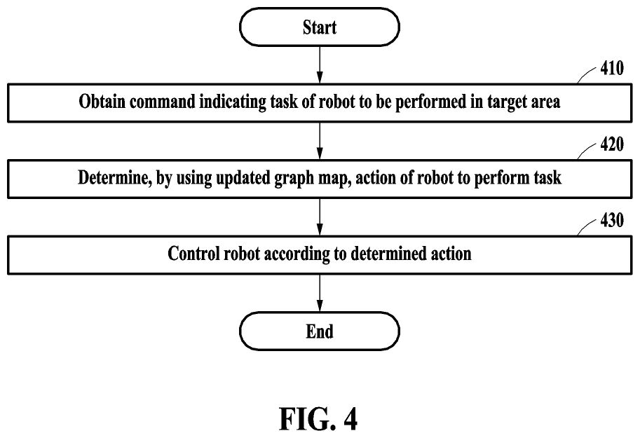

FIG. 4 illustrates a flowchart of an example method of updating a graph map performed by an electronic device according to one or more embodiments.

The electronic device may control a movement of a robot within a target area using the graph map. The robot may be implemented as part of the electronic device (e.g., integrated into the electronic device) or may be an external device (e.g., another electronic device in communication with electronic device).

In operation 410, the electronic device may receive a command indicating a task to be performed by the robot within the target area. The task of the robot may include, for example, an object exploration task to locate or examine an object within the target area.

In operation 420, the electronic device may determine, using an updated graph map, an action for the robot to perform the task. This operation may include determining a position (e.g., a current position) of the robot within the target area. Based on the determined position, the electronic device may determine the action for the robot to execute in order to carry out the task.

For example, the electronic device may receive an image from the robot (e.g., an image captured by a camera mounted on the robot). The electronic device may determine (e.g., estimate or localize) the position of the robot within the target area based on an image received from the robot. For example, the electronic device may extract image features using an image encoder. The image encoder may include a model generated and/or trained to generate output data representing the image features from input data corresponding to the image. The image encoder may be implemented using, for example, a neural network (e.g., a convolutional neural network (CNN)), a transformer, and/or an LLM. The electronic device may determine the position of the robot based on a result of comparing image features extracted from the image received from the robot with image features of image nodes in the graph map.

For example, an electronic device may determine an action of the robot using reinforcement learning. The electronic device may determine a state of the robot within a state space of the robot. The state of the robot may be determined based on the graph map (e.g., an updated graph map) and commands. For example, the state of the robot may include a result of concatenating graph features of the graph map and command features of the commands. The electronic device may determine/select the action from among a plurality of candidate actions, based on a result of applying a reinforcement learning model to the state of the robot. The plurality of candidate actions may include moving forward (e.g., a predetermined distance), turning in a first direction (e.g., clockwise by a predetermined angle), turning in a second direction (e.g., counterclockwise by a predetermined angle), and stopping. The second direction may be opposite the first direction. The reinforcement learning model may be trained using a proximal policy optimization (PPO) objective function and a corresponding reward. For example, the PPO objective function and the reward (R_{language}) may be defined based on Equation 1 below.

$$PPO : {maximize}_{θ} {\hat{𝔼}}_{t} [ min ( \frac{{π}_{θ} ( {a}_{t} \vert {s}_{t} )}{{π}_{old} ( {a}_{t} \vert {s}_{t} )} {\hat{A}}_{t} , clip ( \frac{{π}_{θ} ( {a}_{t} \vert {s}_{t} )}{{π}_{old} ( {a}_{t} \vert {s}_{t} )} , 1 - ϵ , 1 + ϵ ) {\hat{A}}_{t} ) ] \qquad [ Equation 1 ]$$

$${R}_{language} = \{ \begin{matrix}+ 1 & if task completed based on command \\ - 1 & if task deviates from command\end{matrix}$$

In operation 430, the electronic device may control the robot (e.g., through a robot driver) to perform the determined action.

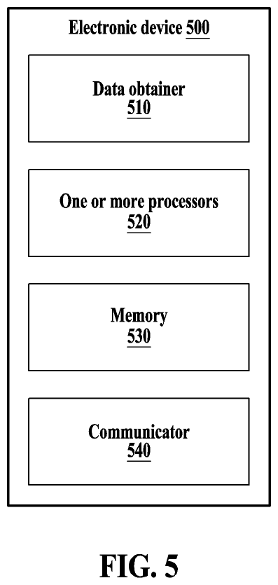

FIG. 5 illustrates an example configuration of an electronic device according to one or more embodiments.

An electronic device 500 may include a data obtainer 510, one or more processors 520, a memory 530, and a communicator 540.

The data obtainer 510 may obtain a graph map and/or a natural language input. For example, the data obtainer 510 may be implemented as part or in combination with the communicator 540 and may obtain the graph map and/or the natural language input from an external device through the communicator 540. For example, the data obtainer 510 may include a vision sensor (e.g., a camera) and generate a graph map based on an image captured by the vision sensor. For example, the data obtainer 510 may include user input components (e.g., a microphone and/or a keyboard) to obtain natural language input via voice and/or text input.

The one or more processors 520 may obtain the graph map and the natural language input from the data obtainer 510. The one or more processors 520 may update the graph map using the natural language input. The one or more processors 520 may include one or more processing circuits.

The memory 530 may temporarily and/or permanently store one or more of the graph map, the natural language input, and the updated graph map. The memory 530 may store instructions corresponding to operations such as obtaining the graph map, obtaining the natural language input, and updating the graph map. The instructions, when executed by the one or more processors 520, may cause the electronic device 500 to perform operations directed by the instructions. However, these are only examples, and information stored in the memory 530 is not limited thereto.

The communicator 540 may transmit and receive one or more of the graph map, the natural language input, and the updated graph map. The communicator 540 may establish wired and/or wireless communication channels with the external device (e.g., another electronic device and a server) and may establish communication with the external device via a long-range communication network, such as cellular communication, short-range wireless communication, local area network (LAN) communication, Bluetooth™, Wi-Fi direct or infrared data association (IrDA), a legacy cellular network, a fourth generation (4G) and/or 5G network, next-generation communication, the Internet, or a computer network (e.g., a LAN or a wide area network (WAN)).

The electronic devices, computing devices, processors, memories, robots, electronic device 500, data obtainer 510, communicator 540, processors 520, memory 530, and other apparatus, devices, and components described herein with respect to FIGS. 1-5 are implemented by or representative of hardware components. Examples of hardware components that may be used to perform the operations described in this application where appropriate include controllers, sensors, generators, drivers, memories, comparators, arithmetic logic units, adders, subtractors, multipliers, dividers, integrators, and any other electronic components configured to perform the operations described in this application. In other examples, one or more of the hardware components that perform the operations described in this application are implemented by computing hardware, for example, by one or more processors or computers. A processor or computer may be implemented by one or more processing elements, such as an array of logic gates, a controller and an arithmetic logic unit, a digital signal processor, a microcomputer, a programmable logic controller, a field-programmable gate array, a programmable logic array, a microprocessor, or any other device or combination of devices that is configured to respond to and execute instructions in a defined manner to achieve a desired result. In one example, a processor or computer includes, or is connected to, one or more memories storing instructions or software that are executed by the processor or computer. Hardware components implemented by a processor or computer may execute instructions or software, such as an operating system (OS) and one or more software applications that run on the OS, to perform the operations described in this application. The hardware components may also access, manipulate, process, create, and store data in response to execution of the instructions or software. For simplicity, the singular term “processor” or “computer” may be used in the description of the examples described in this application, but in other examples multiple processors or computers may be used, or a processor or computer may include multiple processing elements, or multiple types of processing elements, or both. For example, a single hardware component or two or more hardware components may be implemented by a single processor, or two or more processors, or a processor and a controller. One or more hardware components may be implemented by one or more processors, or a processor and a controller, and one or more other hardware components may be implemented by one or more other processors, or another processor and another controller. One or more processors, or a processor and a controller, may implement a single hardware component, or two or more hardware components. A hardware component may have any one or more of different processing configurations, examples of which include a single processor, independent processors, parallel processors, single-instruction single-data (SISD) multiprocessing, single-instruction multiple-data (SIMD) multiprocessing, multiple-instruction single-data (MISD) multiprocessing, and multiple-instruction multiple-data (MIMD) multiprocessing.

The methods illustrated in FIGS. 1-5 that perform the operations described in this application are performed by computing hardware, for example, by one or more processors or computers, implemented as described above implementing instructions or software to perform the operations described in this application that are performed by the methods. For example, a single operation or two or more operations may be performed by a single processor, or two or more processors, or a processor and a controller. One or more operations may be performed by one or more processors, or a processor and a controller, and one or more other operations may be performed by one or more other processors, or another processor and another controller. One or more processors, or a processor and a controller, may perform a single operation, or two or more operations.

Instructions or software to control computing hardware, for example, one or more processors or computers, to implement the hardware components and perform the methods as described above may be written as computer programs, code segments, instructions or any combination thereof, for individually or collectively instructing or configuring the one or more processors or computers to operate as a machine or special-purpose computer to perform the operations that are performed by the hardware components and the methods as described above. In one example, the instructions or software include machine code that is directly executed by the one or more processors or computers, such as machine code produced by a compiler. In another example, the instructions or software includes higher-level code that is executed by the one or more processors or computer using an interpreter. The instructions or software may be written using any programming language based on the block diagrams and the flow charts illustrated in the drawings and the corresponding descriptions herein, which disclose algorithms for performing the operations that are performed by the hardware components and the methods as described above.

The instructions or software to control computing hardware, for example, one or more processors or computers, to implement the hardware components and perform the methods as described above, and any associated data, data files, and data structures, may be recorded, stored, or fixed in or on one or more non-transitory computer-readable storage media. Examples of a non-transitory computer-readable storage medium include read-only memory (ROM), random-access programmable read only memory (PROM), electrically erasable programmable read-only memory (EEPROM), random-access memory (RAM), dynamic random access memory (DRAM), static random access memory (SRAM), flash memory, non-volatile memory, CD-ROMs, CD-Rs, CD+Rs, CD-RWs, CD+RWs, DVD-ROMs, DVD-Rs, DVD+Rs, DVD-RWs, DVD+RWs, DVD-RAMs, BD-ROMs, BD-Rs, BD-R LTHs, BD-REs, blue-ray or optical disk storage, hard disk drive (HDD), solid state drive (SSD), flash memory, a card type memory such as a multimedia card or a micro card (for example, secure digital (SD) or extreme digital (XD)), magnetic tapes, floppy disks, magneto-optical data storage devices, optical data storage devices, hard disks, solid-state disks, and any other device that is configured to store the instructions or software and any associated data, data files, and data structures in a non-transitory manner and provide the instructions or software and any associated data, data files, and data structures to one or more processors or computers so that the one or more processors or computers can execute the instructions. In one example, the instructions or software and any associated data, data files, and data structures are distributed over network-coupled computer systems so that the instructions and software and any associated data, data files, and data structures are stored, accessed, and executed in a distributed fashion by the one or more processors or computers.

While this disclosure includes specific examples, it will be apparent after an understanding of the disclosure of this application that various changes in form and details may be made in these examples without departing from the spirit and scope of the claims and their equivalents. The examples described herein are to be considered in a descriptive sense only, and not for purposes of limitation. Descriptions of features or aspects in each example are to be considered as being applicable to similar features or aspects in other examples. Suitable results may be achieved if the described techniques are performed in a different order, and/or if components in a described system, architecture, device, or circuit are combined in a different manner, and/or replaced or supplemented by other components or their equivalents.

Therefore, in addition to the above disclosure, the scope of the disclosure may also be defined by the claims and their equivalents, and all variations within the scope of the claims and their equivalents are to be construed as being included in the disclosure.

What is claimed is:

1. A processor-implemented method, the method comprising:
generating a graph map of a target area;
obtaining a natural language input describing a change that has occurred in the target area; and
updating the graph map based on a result of applying the change to the graph map using the obtained natural language input.

2. The method of claim 1, wherein the generating of the graph map comprises:
adding, based on an image captured of at least a portion of the target area, an image node corresponding to the image to the graph map.

3. The method of claim 1, wherein the generating of the graph map comprises:
adding an object node corresponding to the object to the graph map; and
adding an edge connecting an image node corresponding to the image to the object node.

4. The method of claim 3, wherein the adding of the object node comprises:
storing object status information indicating a status of the object together with identification information of the object node.

5. The method of claim 1, wherein the generating of the graph map comprises:
determining reachability between a first position corresponding to a first image node and a second position corresponding to a second image node; and
adding an edge connecting the first image node to the second image node in response to a determination that traversal is possible.

6. The method of claim 1, wherein the updating of the graph map comprises:
determining a target place and/or a target object associated with the change, based on the natural language input; and
modifying a target node corresponding to the target place and/or the target object in the graph map.

7. The method of claim 6, wherein the modifying of the target node comprises:
extracting, from the graph map, a sub-graph map comprising the target node, based on a result of applying an encoder to input data corresponding to the graph map and the target place and/or the target object; and
updating the sub-graph map based on information associated with the target place and/or the target object.

8. The method of claim 7, wherein the updating of the sub-graph map comprises:
modifying node features of nodes in the sub-graph map based on the information associated with the target place and/or the target object; and
adding or removing at least one edge connecting the nodes in the sub-graph map based on the modified node features.

9. The method of claim 1, further comprising:
obtaining a command indicating a task to be performed by a robot in the target area;
determining, using the updated graph map, an action for the robot to perform the task; and
controlling the robot to perform the determined action.

10. The method of claim 9, wherein the determining of the action comprises:
determining a state of the robot in a state space of the robot; and
selecting the action from a set of candidate actions based on a result of applying a reinforcement learning model to the state of the robot.

11. A non-transitory computer-readable storage medium storing one or more instructions,
wherein the one or more instructions, when executed by one or more processors of an electronic device, cause the electronic device to:
generate a graph map of a target area;
obtain a natural language input describing a change that has occurred in the target area; and
update the graph map based on a result of applying the change to the graph map using the obtained natural language input.

12. An electronic device comprising:
one or more processors each comprising a processing circuit; and
a memory comprising one or more storage media storing instructions,
wherein the instructions, when executed by the one or more processors individually or collectively, cause the electronic device to:
generate a graph map of a target area;
obtain a natural language input describing a change that has occurred in the target area; and
update the graph map based on a result of applying the change to the graph map using the obtained natural language input.

13. The electronic device of claim 12, wherein the instructions, when executed by the one or more processors individually or collectively, cause the electronic device to:
add, based on an image captured of at least a portion of the target area, an image node corresponding to the image to the graph map.

14. The electronic device of claim 12, wherein the instructions, when executed by the one or more processors individually or collectively, cause the electronic device to:
add, based on detecting an object in an image captured of at least a portion of the target area, an object node corresponding to the object to the graph map; and
add an edge connecting an image node corresponding to the image to the object node.

15. The electronic device of claim 14, wherein the instructions, when executed by the one or more processors individually or collectively, cause the electronic device to:
store object status information indicating a status of the object together with identification information of the object node.

16. The electronic device of claim 12, wherein the instructions, when executed by the one or more processors individually or collectively, cause the electronic device to:
determine reachability between a first position and a second position corresponding to respective image nodes; and
add an edge connecting the first image node to the second image node in response to a determination of the reachability.

17. The electronic device of claim 12, wherein the instructions, when executed by the one or more processors individually or collectively, cause the electronic device to:
determine a target place and/or a target object based on the natural language input; and
modify information on a target node in the graph map corresponding to the target place and/or the target object.

18. The electronic device of claim 17, wherein the instructions, when executed by the one or more processors individually or collectively, cause the electronic device to:
extract, from the graph map, a sub-graph map comprising the target node, based on a result of applying an encoder to input data corresponding to the graph map and the target place and/or the target object; and
update the sub-graph map based on the target place and/or the target object.

19. The electronic device of claim 18, wherein the instructions, when executed by the one or more processors individually or collectively, cause the electronic device to:
change node features of nodes in the sub-graph map based on the target place and/or the target object; and
add or remove at least one edge connecting the nodes based on the changed node features.

20. The electronic device of claim 12, wherein the instructions, when executed by the one or more processors individually or collectively, cause the electronic device to:
obtain a task command for a robot;
determine, using the updated graph map, an action for the robot; and
control the robot in the target area according to the determined action.

21. A method of updating a structured representation of a physical environment, the method comprising:
generating, by an electronic device, a first graph map representing a physical layout of a target area, the graph map comprising a plurality of nodes and edges, wherein the plurality of nodes represent objects or positions within the target area;
receiving, by the electronic device, a natural language input describing a change to the target area;
extracting, based on the natural language input, a target feature representing at least one of a target object or a target location;
determining, based on the target feature and the first graph map, at least one target node associated with the change;
modifying, by the electronic device, one or more node features of the target node based on the natural language input; and
generating a second graph map by updating the first graph map to reflect the modified node features.
